(19) United States
(12) Patent Application Publication
(10) Pub. No.: US 2010/0226670 A1
(43) Pub. Date: Sep. 9, 2010

(54) IMAGE FORMING APPARATUS AND IMAGE FORMING METHOD

(75) Inventors: Hiroshi TOYAMA, Shiojiri-shi (JP); Ken IKUMA, Suwa-shi (JP)

Correspondence Address: Workman Nydegger;1000 Eagle Gate Tower, 60 East South Temple, Salt Lake City, UT, 84111, US

(73) Assignee: Seiko Epson Corporation, Tokyo (JP)

(21) Appl. No.: 12/703,599

(22) Filed: Feb. 10, 2010

(30) Foreign Application Priority Data
Mar. 3, 2009 (JP) 2009-048765
Oct. 27, 2009 (JP) 2009-246426

(51) Int. Cl. G03G 15/043; G03G 13/04

(52) U.S. Cl. 399/51

(57) ABSTRACT

An image forming apparatus includes a first latent image carrier that forms a first latent image, a first charging unit that charges the first latent image carrier, and a first exposure unit that exposes the first latent image carrier to light, forming the first latent image. A first developing unit develops the first latent image with a first liquid developer. A second latent image carrier forms a second latent image. A second charging unit charges the second latent image carrier, which is exposed by a second exposure unit to light, forming the second latent image. A second developing unit develops the second latent image with a second liquid developer. Developed images of the first and second latent image carriers are transferred by a transfer member. A light amount controlling unit adjusts an exposed light amount of the first or the second exposure unit according to image information.

### BACKGROUND

1. Technical Field

The present invention relates to an image forming apparatus and an image forming method using a liquid developer that contains a carrier liquid and a toner.

2. Related Art

In an image forming apparatus using a liquid developer, there is a case where an image defect occurs due to occurrence of a phenomenon called a rib. A rib is a phenomenon where, when carrier oil is separated into a developing roller side and a photoreceptor side of an outlet of a nip of the developing roller and the photoreceptor, the carrier oil is pulled into a thread to be dropped from the developing roller side to the photoreceptor side, and toner particles that cannot be moved from the nip are attracted to the carrier oil and dropped to the photoreceptor side.

In related art, there has been suggested that, when a horizontal line of characters, line drawings, or the like is printed, an image defect where the line is broken off or the thickness of the line is not uniform caused by ribs, is improved by providing a process of compressing the toner before development (JP-A-2002-278291).

However, in the image forming device disclosed in JP-A-2002-278291, there was a case where excessive compression results in cohesion of the toner.

### SUMMARY

An advantage of some aspects of the invention is that it provides an image forming apparatus and an image forming method which enables the reduction of the rib of an image by adjusting the exposed light amount of a first exposure unit and/or a second exposure unit based on image information.

According to an aspect of the invention, there is provided an image forming apparatus including a first latent image carrier where a first latent image is formed, a first charging unit that charges the first latent image carrier, a first exposure unit that exposes the first latent image carrier charged by the first charging unit to light to form the first latent image, a first developing unit that develops the first latent image formed in the first latent image carrier with a first liquid developer, a second latent image carrier where a second latent image is formed, a second charging unit that charges the second latent image carrier, a second exposure unit that exposes the second latent image carrier charged by the second charging unit to light to form the second latent image, a second developing unit that develops the second latent image formed in the second latent image carrier with a second liquid developer, a transfer member where a developed image of the first latent image carrier is transferred and then a developed image of the second latent image carrier is transferred, an input unit where image data including image information is input, and a light amount controlling unit that adjusts an exposed light amount of the first exposure unit or an exposed light amount of the second exposure unit according to the image information of the image data input to the input unit.

Furthermore, according to the above aspect of the invention, the light amount controlling unit controls the exposed light amount of the first exposure unit or the exposed light amount of the second exposure unit to make the exposed light amount of the second exposure unit greater than the exposed light amount of the first exposure unit.

Furthermore, according to another aspect of the invention, there is provided an image forming apparatus including a first latent image carrier where a first latent image is formed, a first charging unit that charges the first latent image carrier, a first exposure unit that exposes the first latent image carrier charged by the first charging unit to light to form the first latent image, a first developing unit that develops the first latent image formed in the first latent image carrier with a first liquid developer, a second latent image carrier where a second latent image is formed, a second charging unit that charges the second latent image carrier, a second exposure unit that exposes the second latent image carrier charged by the second charging unit to light to form the second latent image, a second developing unit that develops the second latent image formed in the second latent image carrier with a second liquid developer, a transfer member where a developed image of the first latent image carrier is transferred and then a developed image of the second latent image carrier is transferred, an input unit where image data including image information is input, and a light amount controlling unit that adjusts an exposed light amount of the first exposure unit and an exposed light amount of the second exposure unit according to the image information of the image data input to the input unit.

Furthermore, according to the above aspect of the invention, the light amount controlling unit performs control to make the exposed light amount of the second exposure unit greater than the exposed light amount of the first exposure unit.

Furthermore, according to the above aspect of the invention, the light amount controlling unit makes a difference between the exposed light amount of the first exposure unit and the exposed light amount of the second exposure unit controlled when the image information is first image information different from a difference between the exposed light amount of the first exposure unit and the exposed light amount of the second exposure unit controlled when the image information is second image information which is different from the first image information.

Furthermore, according to the above aspect of the invention, the light amount controlling unit controls the exposed light amount of the first exposure unit or the exposed light amount of the second exposure unit so as to have a first exposed light amount when the number of printed dots in a predetermined region of the image data is a first number of printed dots, and controls the exposed light amount of the first exposure unit or the exposed light amount of the second exposure unit so as to have a second exposed light amount, which is greater than the first exposed light amount, when the number of printed dots in the predetermined region of the image data is a second number of printed dots, which is smaller than the first number of printed dots.

Moreover, according to still another aspect of the invention, there is provided an image forming method including inputting image data including image information, adjusting an exposed light amount of a first exposure unit and an exposed light amount of a second exposure unit based on the image information of the image data, developing a latent image formed by exposing a first latent image carrier to light in the adjusted exposed light amount of the first exposure unit with a first liquid developer, transferring the developed image to a transfer member, developing a latent image formed by exposing a second latent image carrier to light in the adjusted exposed light amount of the second exposure unit with a second liquid developer, and transferring the developed image to the transfer member.

According to the image forming apparatus and the image forming method of the invention, it is possible to reduce ribs in an image by adjusting exposed light amounts of the first exposure unit and/or the second exposure unit based on the image information.

Furthermore, it is possible to easily control the exposed light amounts with a simple configuration of the light amount controlling unit.

Furthermore, it is possible to reduce ribs in an image because of the exposed light amount of an exposure unit later in order of transfer in which ribs easily occur.

### BRIEF DESCRIPTION OF THE DRAWINGS

The invention will be described with reference to the accompanying drawings, wherein like numbers reference like elements.

FIG. 1 is a diagram illustrating an embodiment of an image forming apparatus.

FIG. 2 is a diagram illustrating a developing device and a peripheral section of a photoreceptor for yellow.

FIG. 3 is a block diagram relating to a light amount controlling system of the present embodiment.

FIGS. 4A and 4B are diagrams illustrating a binarization process.

FIG. 5 is a diagram illustrating a look-up table.

FIG. 6 is a diagram illustrating a print sample S used in an example.

### DESCRIPTION OF EXEMPLARY EMBODIMENTS

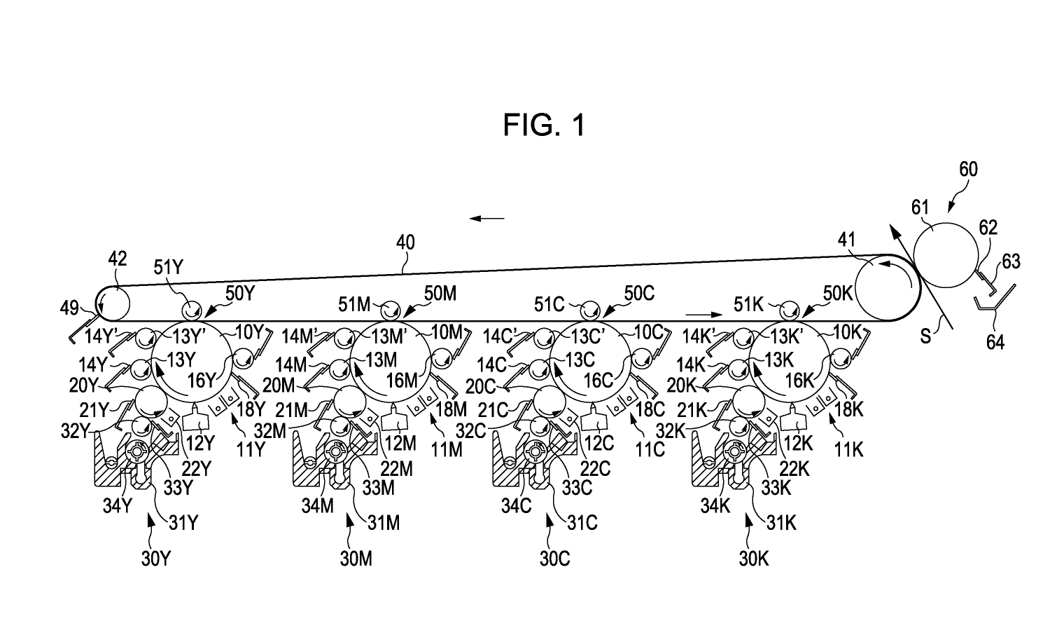

Hereinafter, an embodiment of the invention will be described with reference to accompanying drawings. FIG. 1 is a diagram illustrating main constituent elements of the image forming apparatus according to an embodiment of the invention. With respect to peripheral sections of photoreceptors for each color provided in the center portion of the image forming apparatus, developing devices 30Y, 30M, 30C, and 30K as developing units are provided in the lower part of the image forming apparatus, and components such as a transfer belt 40, a secondary transferring unit 60, and the like are provided in the upper part of the image forming apparatus.

The developing devices 30Y, 30M, 30C, and 30K are provided with photoreceptors 10Y, 10M, 10C, and 10K as latent image carriers, chargers 11Y, 11M, 11C, and 11K, exposure units 12Y, 12M, 12C, and 12K such as an LED array (or an organic EL device array), and the like. The charger 11Y, 11M, 11C, and 11K uniformly charge the photoreceptors 10Y, 10M, 10C, and 10K, the exposure units 12Y, 12M, 12C, and 12K perform exposure based on input image signals, and thereby electrostatic latent images are formed on the charged the photoreceptors 10Y, 10M, 10C, and 10K.

The developing devices 30Y, 30M, 30C, and 30K are mainly provided with developing rollers 20Y, 20M, 20C, and 20K, developer containers (reserves) 31Y, 31M, 31C, and 31K that store liquid developers of respective colors including yellow (Y), magenta (M), cyan (C), and black (K), anilox rollers 32Y, 32M, 32C, and 32K as applying rollers that apply the liquid developers of each color to the developing rollers 20Y, 20M, 20C, and 20K from the developer containers (reserves) 31Y, 31M, 31C, and 31K, and the like, and develop an electrostatic latent image formed on the photoreceptors 10Y, 10M, 10C, and 10K with the liquid developers of each color.

The transfer belt 40 is stretched to a belt driving roller 41 and a tension roller 42, as an endless belt, and driven by the belt driving roller 41 coming into contact with the photoreceptors 10Y, 10M, 10C, and 10K in first transferring units 50Y, 50M, 50C, and 50K. The first transferring units 50Y, 50M, 50C, and 50K is provided facing with first transfer rollers 51Y, 51M, 51C, and 51K and interposing the transfer belt 40 with the photoreceptors 10Y, 10M, 10C, and 10K, and transfer a developed toner image of each color on the photoreceptors 10Y, 10M, 10C, and 10K by sequentially superimposing the image on the transfer belt 40 having the position contacting with the photoreceptors 10Y, 10M, 10C, and 10K as a transfer position to form a toner image with full colors.

The secondary transferring unit 60 is provided facing with the belt driving roller 41 and interposing the transfer belt 40 with the secondary transfer roller 61, and further provided with a cleaning device constituted with a secondary transfer roller cleaning blade 62. In addition, in the transfer position where the secondary transfer roller 61 is provided, a toner image with single color or a toner image with full colors formed on the transfer belt 40 is transferred to a transferring material such as paper, film, fabric, or the like fed to a transferring material feeding route Ca.

The tension roller 42 stretches the transfer belt 40 with the belt driving roller 41. In a spot where the transfer belt 40 is stretched in the tension roller 42, the cleaning device constituted with the transfer belt cleaning blade 49 is provided and comes into contact with thereto, and thereby enabling to clean toner and carrier remaining on the transfer belt 40.

The supply of transferring materials to the image forming apparatus is performed by a feeding device (not shown in the drawing). The transferring materials set in such a feeding device are sent out to the transferring material feeding route Ca one by one in a predetermined timing. In the transferring material feeding route Ca, a transferring material is fed to a secondary transfer position, and a developed toner image with a single color or a developed toner image with full colors formed on the transfer belt 40 is transferred to the transferring material. The transferring material subjected to the secondary transfer is fed further to a fixing unit (not shown). The fixing unit is constituted with a heating roller (not shown), and a pressure roller biased with predetermined pressure in the heating roller side. By inserting the transferring material between such nips, a toner image with a single color or a toner image with full colors transferred onto the transferring material is fused with and fixed to the transferring material such as paper or the like.

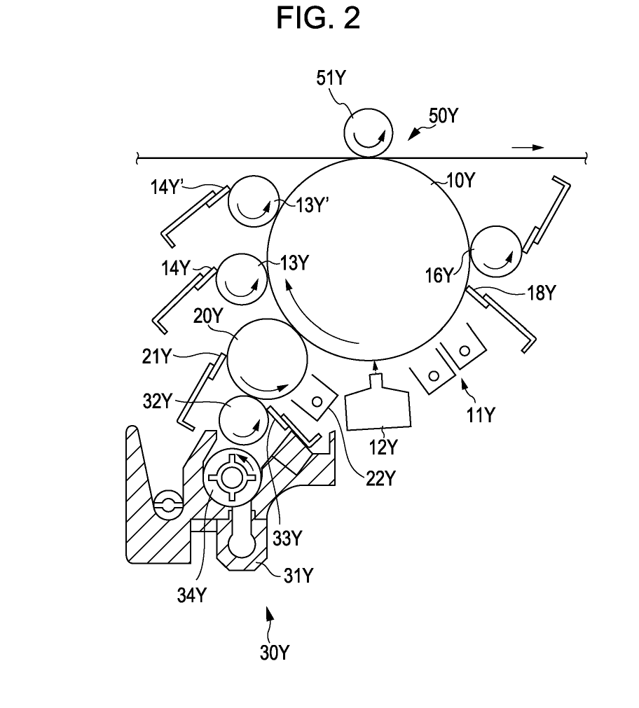

Here, a peripheral section of the photoreceptors and the developing device will be described. FIG. 2 is a diagram illustrating a peripheral section of the photoreceptor for yellow and the developing device. Since peripheral sections of the photoreceptors for each color and the developing devices are configured same as one another, hereinafter, there will be provided description based on the peripheral section of the photoreceptor for yellow (Y) and the developing device thereof.

The peripheral section of the photoreceptor is provided with a photoreceptor cleaning roller 16Y, a photoreceptor cleaning blade 18Y, a corona charger 11Y, the exposure unit 12Y, the developing roller 20Y of the developing device 30Y, a first photoreceptor squeeze roller 13Y, and a second photoreceptor squeeze roller 13Y′, along the rotation direction in the outer circumference of the photoreceptor 10Y.

The photoreceptor cleaning roller 16Y cleans liquid developer remaining after transfer and liquid developer not transferred on the photoreceptor 10Y by rotating counterclockwise direction and coming into contact with the photoreceptor 10Y. To photoreceptor cleaning roller 16Y, a bias voltage attracting toner particles in the liquid developer is applied, and a collected substance of the photoreceptor cleaning roller 16Y is a liquid developer enriched with solid contents containing a lot of toner particles.

The photoreceptor cleaning blade 18Y coming into contact with the photoreceptor 10Y cleans a liquid developer enriched with a carrier component on the photoreceptor 10Y in the downstream side of the photoreceptor cleaning roller 16Y.

A developing roller cleaning blade 21Y, a anilox roller 32Y, and a compaction corona generator 22Y are provided in the outer circumference of the developing roller 20Y in the developing device 30Y. A regulating blade 33Y that adjusts the amount of the liquid developer supplied to the developing roller 20Y comes into contact with the anilox roller 32Y. An auger 34Y is reserved in the developer container 31Y. In addition, a first transfer roller 51Y of the first transfer unit is provided in a position facing with the photoreceptor 10Y interposing the transfer belt 40.

The photoreceptor 10Y is a photoreceptor drum constituted with a cylindrical member where a photoreceptive layer such as an amorphous silicon photoreceptor is formed in the outer circumferential surface, and rotates in a clockwise direction.

The corona charger 11Y is provided in the upstream side of the nip portion of the photoreceptor 10Y and the developing roller 20Y in the rotation direction of the photoreceptor 10Y, and performs corona charge to the photoreceptor 10Y by applying a voltage from a power supply device which is not shown. The exposure unit 12Y irradiates the photoreceptor 10Y charged by the corona charger 11Y with light in the downstream side of the corona charger 11Y in the rotation direction of the photoreceptor 10Y and forms a latent image on the photoreceptor 10Y. In addition, it is defined that the configuration of rollers provided in fore stages are in the upper stream than the configuration of rollers provided in back stages from the start to the end of the image forming process.

The developing device 30Y includes the compaction corona generator 22Y that performs an action of compaction and the developer container 31Y that stores the liquid developer in a state where a toner in a carrier is dispersed in the ratio of about 20% by weight.

Furthermore, the developing device 30Y includes the developing roller 20Y that carries the liquid developer, the anilox roller 32Y that is a applying roller for applying the liquid developer on the developing roller 20Y, the regulating blade 33Y that regulates an amount of the liquid developer to be applied on the developing roller 20Y, the auger 34Y that supplies the liquid developer to the anilox roller 32Y while stirring and feeding the developer, the compaction corona generator 22Y that allows the liquid developer carried by the developing roller 20Y to be in a compaction state, and the developing roller cleaning blade 21Y that cleans the developing roller 20Y.

The liquid developer reserved in the developer container 31Y is not a volatile liquid developer with volatility at room temperature, low concentration (about 1 to 2 wt %) and low viscosity having Isopar (a trade name made by Exxon) as a carrier, which is generally used in the related art, but a nonvolatile liquid developer with nonvolatility at room temperature, high concentration, and high viscosity. In other words, the liquid developer according to the invention is a liquid developer with high viscosity (about 30 to 10000 mPa·s) having the concentration of toner solid content of about 20% by adding a solid substance with the average particle diameter of 1 μm obtained by dispersing a coloring agent such as a pigment into a thermoplastic resin to a liquid solvent such as an organic solvent, silicon oil, mineral oil, cooking oil, or the like together with a dispersing agent.

The anilox roller 32Y supplies the liquid developer to the developing roller 20Y and functions as a applying roller for performing application. The anilox roller 32Y is formed of a cylindrical member and is a roller where a concave-convex surface is formed having a groove finely and uniformly carved in a spiral shape on the surface so that the surface can easily carry the developer. The anilox roller 32Y enables the supply of the liquid developer from the developer container 31Y to the developing roller 20Y. During the operation of the apparatus, as shown in FIG. 1, the auger 34Y rotates in the clockwise direction, supplies the liquid developer to the anilox roller 32Y, and the anilox roller 32Y rotates in the counterclockwise direction, and applies the liquid developer onto the developing roller 20Y.

The regulating blade 33Y is an elastic blade of which the surface is coated with an elastic body, and constituted with a rubber section made of urethane rubber or the like coming into contact with the surface of the anilox roller 32Y. In addition, the regulating blade 33Y regulates and adjusts the film thickness and the amount of the liquid developer carried and fed by the anilox roller 32Y, and adjusts the amount of the liquid developer supplied to the developing roller 20Y.

The developing roller cleaning blade 21Y is formed of rubber or the like coming into contact with the surface of the developing roller 20Y, provided in the downstream side of the developing nip portion where the developing roller 20Y comes into contact with the photoreceptor 10Y in the rotation direction of the developing roller 20Y to remove by scraping off the liquid developer remaining in the developing roller 20Y.

The compaction corona generator 22Y is an electric field applying unit that increases a charging bias on the surface of the developing roller 20Y, and electric field is applied from the compaction corona generator 22Y side toward the developing roller 20Y in a region subjected to compaction by the compaction corona generator 22Y. In addition, as an electric field applying unit for the compaction, a compaction roller or the like may be used in lieu of the corona generator for corona generation shown in FIG. 1.

The developer carried to the developing roller 20Y and subjected to the compaction is used for development of a latent image on the photoreceptor 10Y by the application of predetermined electric field in a developing nip portion where the developing roller 20Y comes into contact with the photoreceptor 10Y.

The developer remaining after the development is scraped off to be removed by the developing roller cleaning blade 21Y and dropped in a collection section in the developer container 31Y to be reused. In addition, the carrier and the toner reused in that manner are not in a mixed state.

A photoreceptor squeeze device provided on the upstream side of the first transfer is provided in the downstream side of the developing roller 20Y facing with the photoreceptor 10Y and collects surplus carrier of a toner image developed on the photoreceptor 10Y. The photoreceptor squeeze device is constituted with a first photoreceptor squeeze roller 13Y made of an elastic roller member rotating and slidably contacting with the photoreceptor 10Y, and a second photoreceptor squeeze roller 13Y′, collects surplus carrier and originally unnecessary fogging toner from a toner image developed on the photoreceptor 10Y, and functions to raise the ratio of toner particles in a developed image (toner image). In addition, the photoreceptor squeeze rollers 13Y and 13Y′ are applied with a predetermined bias voltage.

The surface of the photoreceptor 10Y that passes the squeeze device constituted with the first photoreceptor squeeze roller 13Y and the second photoreceptor squeeze roller 13Y′ advances to a first transferring unit 50Y.

In the first transferring unit 50Y, a developer image developed on the photoreceptor 10Y is transferred to the transfer belt 40 by the first transfer roller 51Y. In the first transferring unit, the toner image on the photoreceptor 10Y is transferred to the transfer belt 40 side by the action of the transferring bias applied to the first transfer roller 51Y. Here, the photoreceptor 10Y and the transfer belt 40 is configured to move at the same speed, lessen the driving burden of the rotation and the movement, and suppress disturbance of the photoreceptor 10Y to the developed image (toner image).

With the same process as the developing process of the developing devices 30Y, the developing device 30M, 30C, and 30K form toner images of magenta (M), cyan (C), and black (K) on the photoreceptors 10M, 10C, and 10K respectively. In addition, the transfer belt 40 passes through the nip of the first transferring unit 50 of colors of yellow (Y), magenta (M), cyan (C), and black (K), and the developer (developed image) on the photoreceptors of each color is transferred, and advances to the nip portion of the secondary transferring unit 60 in a manner of superimposing colors.

The transfer belt 40 that passes the secondary transferring unit 60 revolves in order to receive a transferred image in the first transferring unit 50 again. However, the transfer belt 40 is subjected to cleaning by the transfer belt cleaning blade 49 in the upstream side where the first transferring unit 50 is operated.

The transfer belt 40 is provided with an elastic interlayer made of polyurethane on a polyimide base layer, and configured to have a three-tier structure where a PFA surface layer is further provided thereon. The transfer belt 40 is stretched to the driving roller 41 and the tension roller 42 in the polyimide base layer side, and used so as to transfer the toner image in the PFA surface layer side. The transfer belt 40 having the elasticity formed in that way is effective for transferring by sending toner particles with a particularly small particle diameter into a concave portion of the transferring material during the secondary transfer, due to better following and responding property of the surface of the transferring material.

Next, the image forming apparatus and the image forming method according to the present embodiment will be described in detail.

First, the surface of the photoreceptor 10Y is uniformly charged by using the charger 11Y to the photoreceptor 10Y to apply positive corona to the surface so that the potential of the surface is about 600 V. As the charger 11Y, a corotron charger, a scorotron charger, or the like is used. Furthermore, it does not matter if a contract type method such as roller charge, and the like is used. In the present embodiment, as shown in FIGS. 1 and 2, 2 corotron chargers are used. The voltage applied to a wire is about 5000 V and the voltage applied to a house is about 800 V.

Next, the exposure unit 12Y irradiates the photoreceptor 10Y with light. The portion irradiated with the light can have the potential of the surface given by the charger 11Y dropped to 50 V to 100 V. This is because the portion irradiated with the light generates carriers and eliminates electric charges given by the charger 11Y, as a characteristic of the photoreceptor 10Y. There are an organic photoreceptor, an amorphous silicon photoreceptor, and the like as for the photoreceptor 10Y, but in the present embodiment, amorphous silicon is used as shown in FIGS. 1 and 2. In addition, the exposure unit 12Y uses a laser as a light emitting source, and there are a laser scanner type, which scans laser light onto the photoreceptor 10Y using a mirror such as a polygon or the like, and a line head type, which lights each element individually by arranging a plurality of light emitting sources such as LED or the like in series. In the present embodiment, an LED line head is used, but it does not matter if a different light source such as an organic EL is used as the light source.

Next, the liquid developer on the photoreceptor 10Y is used for development by the developing roller 20Y. In the liquid developer, toner particles in the size of about 1 to 2 μm are dispersed in the oil called carrier liquid. With the liquid developer, a layer with the thickness of about 5 to 7 μm is formed on the developing roller 20Y. The developing roller 20Y rotates in the counterclockwise direction as shown in FIG. 2, in other words, rotates following the circumference of the photoreceptor 10Y. The developing roller 20Y comes into contact with the photoreceptor 10Y during the development and the development is performed by moving the toner particles from the developing roller 20Y to the image portion on the photoreceptor 10Y. In addition, the corotron charger 11Y is provided in the fore side of the portion where the developing roller 20Y comes into contact with the photoreceptor 10Y having a function of compressing the toner particles in the developing roller 20Y side by applying a bias. The house of the corotron charger 11Y is in OV state (grounded to the earth), and applies a bias (compaction bias) of about 3000 V to 4000 V to the wire.

The bias applied to the developing roller 20Y (developing bias) is set to about 400 V to 550 V. With the setting of the bias, a difference with the potential of the image portion of the photoreceptor 10Y is about 300 V to 500 V, and the toner particles can be moved to the photoreceptor 10Y side in order to have positive electric charges. To the contrary, the potential of the surface of the photoreceptor 10Y in the no-image portion side is about 600 V, which is higher than the developing bias, and thereby the toner particles are set not to be moved.

Next, the oil in the liquid developer used for the development on the photoreceptor 10Y is collected by the squeeze rollers 13Y, and 13Y′. Since only the toner particles are necessary for forming an image, and using the oil is wasteful, the oil is collected and reused by the squeeze rollers 13Y, and 13Y′, if possible. The biases applied to the squeeze rollers 13Y, and 13Y′ are about 400 V to 450 V, and it is possible to collect the oil with the voltage, without scraping off the image (toner particle) on the photoreceptor 10Y. If the bias is low, the liquid developer is divided between the squeeze rollers 13Y, and 13Y′ and the photoreceptor 10Y, thereby forming ribs. In the present embodiment, as shown in FIGS. 1 and 2, the squeeze rollers are provided 2, as 13Y and 13Y′, and collects and returns the oil to the developer container.

As such, the image formed with the liquid developer on the photoreceptor 10Y is transferred to the transfer belt 40 by applying a bias to the first transfer roller 51Y. Some of the liquid developer remaining on the photoreceptor 10Y without being transferred to the transfer belt 40 is collected by the cleaning blade 18Y. In addition, the charger 11Y and the exposure unit 12Y reset the electric potential on the surface of the photoreceptor 10Y using a neutralization lamp (not shown in the drawing) called an eraser.

Next, a light amount controlling system 100 of the image forming apparatus will be described.

In the past, copy machines of electrophotographic type employed an analog scheme in which light is irradiated to a document and reflected light is irradiated to a photoreceptor. Recently, copy machines mostly employ the digital scheme in which readout of a document is stored in memory or the like as a data, by receiving reflected light by light receiving elements such as a CCD. In the copy machines of the digital scheme, exposure devices of line head type are used which have laser scanning device, LED, or the like as light sources in order to irradiate photoreceptors with light.

In the analog scheme used in the past, since a photoreceptor is directly irradiated with reflected light of a document, shading was expressed with the intensity of the light. On the other hand, in the digital scheme, a readout document is processed for binarization, and shading is expressed with ON/OFF of an exposure unit.

Furthermore, in case of printers of electrophotographic type, PCs or the like directly send data. In this case, the data are processed for binarization in the same manner, and shading is expressed through ON/OFF state of an exposure unit. Moreover, in case of color digital copy machines or color printers, it is the same that shading is expressed with binarization, even though there is a process of color conversion (RGB to YMCK, or the like).

In order to reduce ribs in characters and line drawings, it is effective to finish the movement of toner particles within the transit time of the developing nip. To that end, it is possible to strongly form a latent image of a photoreceptor and to draw a line by making exposure energy greater. However, if the exposure energy gets greater, shading expression in a shadow portion (a portion having high concentration) is lost in a natural image such as a photograph or the like.

Therefore, since the influence of ribs in a natural image is hardly perceivable to the human eye, the image forming apparatus according to the invention can solve ribs in a line drawing, and secure the grayscale (shading) reproduction properties of a natural image by having a small exposure energy when a natural image is formed and a greater exposure energy when a line drawing such as a character is formed. In addition, the image forming apparatus according to the invention reduces ribs by raising the exposed light amount of a color later in the order of transfer in which ribs easily occur by the transfer.

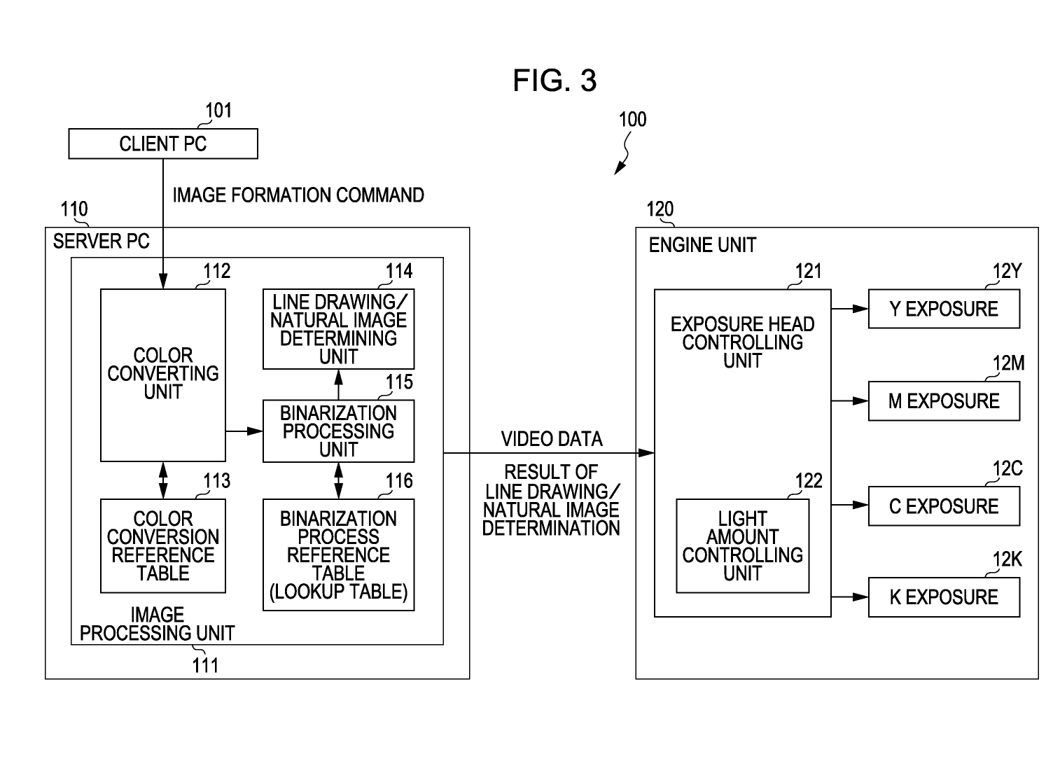

FIG. 3 is a block diagram relating to the light amount controlling system 100 according to the present embodiment.

When a command of image formation is sent from a client PC 101, a server PC 110 receives print data and performs image processing.

An image processing unit 111 first performs conversion for the print data received from the client PC 101 from RGB to CMYK or from CMYK to CMYK while referring to a color conversion reference table 113 in a color converting unit 112 as an input unit.

The color conversion reference table 113 prepares a conversion table by measuring color reproduction of an engine.

Next, in the image processing unit 111, the data subjected to the color conversion to CMYK (8 bit for each color/32 bit for 4 colors) are processed for binarization to a printed portion and non-printed portion for each dot in a binarization processing unit 115 and video data (1 bit) are generated for each of the colors.

In the binarization process, ON/OFF data for each pixel (video data) are generated while referring to the binarization process reference table 116.

Furthermore, at this point, a line drawing/natural image determining unit 114 determines a line drawing or a natural drawing from the data before the binarization process is performed. For example, if a target pixel has medium concentration, the pixel is determined as a natural image.

The video data generated as above include information on the result of line drawing/natural image determination for each pixel, and are sent to a exposure head controlling unit 121 of an engine unit 120.

The exposure head controlling unit 121 that receives the video data performs ON/OFF control for the exposure units 12Y, 12M, 12C, and 12K of each color and the exposure energy is changed for each pixel of each color by a light amount controlling unit 122.

Each of the exposure units 12Y, 12M, 12C, and 12K uses a line head of 1200 dpi. The units use LEDs and organic ELs as light sources, and in case of using the LEDs, the exposure energy is controlled by controlling light emitting time and lighting time, and in case of using the organic Els, the exposure energy is controlled by controlling applied current or applied voltage by the light amount controlling unit 122.

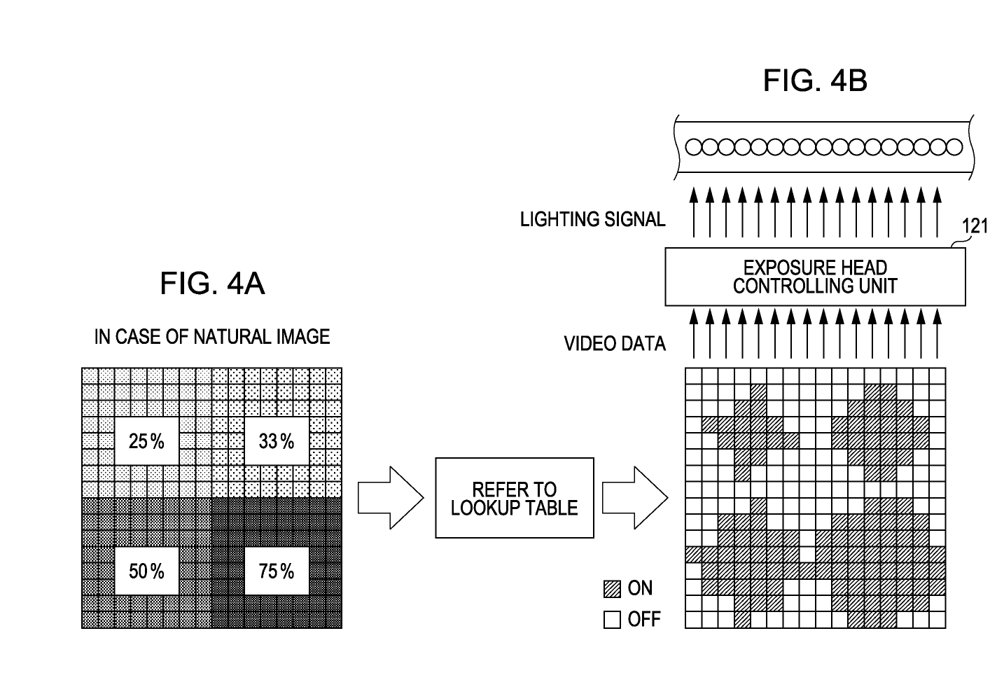

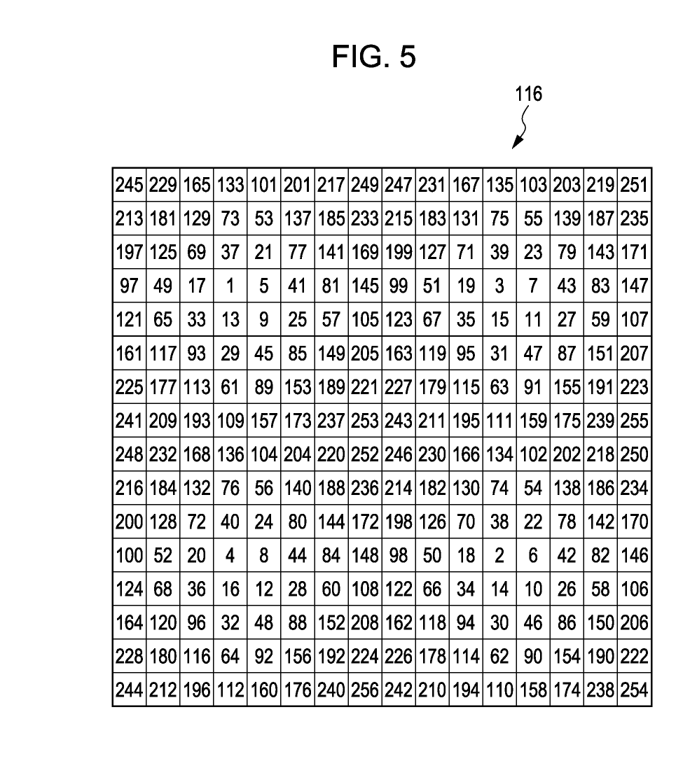

FIGS. 4A and 4B are diagrams illustrating the binarization process, and FIG. 5 is diagram showing a lookup table.

The binarization process is performed by using a reference table called a lookup table 116 as the binarization process reference table 116 as shown in FIG. 5.

The original image data have 4 colors of 32 bit as concentration data with 1 color of 8 bit (256 colors) for each pixel after the color conversion, as shown in FIG. 4A. While the concentration data are compared to the data in the lookup table 116, it is determined for each pixel to be ON or OFF in the binarization processing unit 115, as shown in FIG. 4B.

As shown in FIG. 5, the lookup table 116 is, for example, an 8×8 matrix, and arranged with values from 1 to 256 in the lines and columns. In the arranging way of the values, halftone dots can be formed in the 8×8 matrix as shown in FIG. 4B.

As shown in FIG. 4B, ON/OFF of each pixel in the binarization processing unit 115 is determined and a signal is sent to the exposure head controlling unit 121 as the video data with the method above. At this point, when the original data have grayscales as in a natural image, the exposure energy is determined in the exposure head controlling unit 121 based on the information.

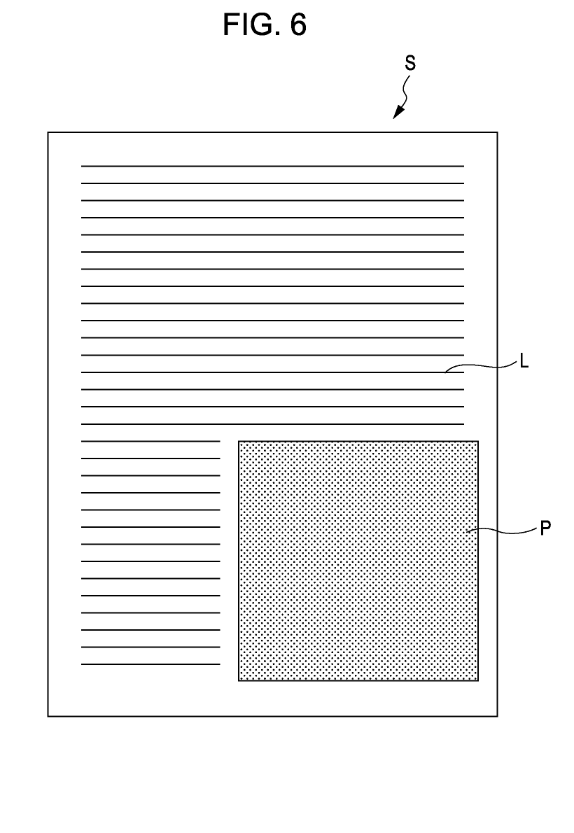

Next, examples will be explained. FIG. 6 is a diagram illustrating a print sample S used in an example. In the example, in a one sheet of printed result, a character/line drawing regions L put with a character/line drawing as first image information and a photograph region P put with a natural image such as a photograph and picture as second image information are formed and evaluation thereof is performed.

In example 1, the print sample S was prepared as shown in FIG. 6 and the exposed light amount was changed in the order of exposure of the character/line drawing region L and the photograph region P as shown in Table 1.

TABLE 1

| | First | Second | Third | Fourth |
|---|---|---|---|---|
| | exposure | exposure | exposure | exposure |
| Photograph region P | 1.0 μJ/cm² | 1.0 μJ/cm² | 1.0 μJ/cm² | 1.0 μJ/cm² |
| Character/line | 1.2 μJ/cm² | 1.5 μJ/cm² | 1.5 μJ/cm² | 1.5 μJ/cm² |
| drawing region L | | | | |

Under the conditions shown in Table 1, the quality of the character/line drawing region L and the photograph region P of the print sample S shown in FIG. 6 was evaluated, and it was possible to suppress ribs in the character and to obtain sufficient grayscale expression even in the photograph. Particularly, in a pattern where the liquid developer is superimposed as a color character, it was possible to reduce the occurrence of the ribs by raising the exposure energy in the later side.

In example 2, the print sample S was prepared as shown in FIG. 6 and the exposed light amount of each color was changed in the order of exposure of the character/line drawing region L and the photograph region P as shown in Table 2.

TABLE 2

| | First | Second | Third | Fourth |
|---|---|---|---|---|
| | exposure | exposure | exposure | exposure |
| Liquid developer | Black | Magenta | Cyan | Yellow |
| Exposed light amount | 1.0 μJ/cm² | 1.0 μJ/cm² | 1.0 μJ/cm² | 1.0 μJ/cm² |
| of the photograph | | | | |
| region P | | | | |
| Dot count of the | 15% | 15% | 10% | 10% |
| character/line | | | | |
| drawing | | | | |
| Exposed light amount | 1.2 μJ/cm² | 1.3 μJ/cm² | 1.4 μJ/cm² | 1.6 μJ/cm² |
| of the | | | | |
| character/line | | | | |
| drawing region L | | | | |

Under the conditions shown in Table 2, the quality of the character/line drawing region L and the photograph region P of the print sample S shown in FIG. 6 was evaluated. The order of the color to be transferred was put as Table 2, the dots from the video data were counted after screen process of the character/line drawing region L, and the exposure energy was determined as shown in FIG. 2. The small number of counted dots brings about many fine lines in the pattern, and thereby it is easy to generate ribs. Therefore, the exposure energy is determined from the ratio of ON/OFF in the character/line drawing region L, the exposed light amount later in the order of the transfer is increased, and thereby it is possible to reduce the ribs.

In example 3, the print sample S was prepared as shown in FIG. 6 and the exposed light amount of each color was changed in the order of exposure of the character/line drawing region L and the photograph region P as shown in Table 3.

TABLE 3

| | First | Second | Third | Fourth |
|---|---|---|---|---|
| | exposure | exposure | exposure | exposure |
| Liquid developer | Yellow | Magenta | Cyan | Black |
| Exposed light amount | 1.0 μJ/cm² | 1.0 μJ/cm² | 1.0 μJ/cm² | 1.0 μJ/cm² |
| of the photograph | | | | |
| region P | | | | |
| Dot count of the | 15% | 10% | 10% | 20% |
| character/line | | | | |
| drawing | | | | |
| Exposed light amount | 1.0 μJ/cm² | 1.3 μJ/cm² | 1.2 μJ/cm² | 1.2 μJ/cm² |
| of the character/line | | | | |
| drawing region L | | | | |

Under the conditions shown in Table 3, the quality of the character/line drawing region L and the photograph region P of the print sample S shown in FIG. 6 was evaluated. The color transferred in the first order was yellow. Yellow is a color which is most difficult to perceive with the human eye even when ribs occur, and the order of transfer for yellow is the most difficult to generate ribs. For that reason, it is possible to make the exposure energy of yellow constant regardless of characters and photographs. Colors in the second order and thereafter can have reduced ribs by having exposure energy as shown in Table 3 above in the character/line drawing region by the dot count and the order of transfer.

In example 4, the print sample S was prepared as shown in FIG. 6 and the exposed light amount was made greater as the order of the transfer becomes late for the image information in a state where the dot count for each color in the character/line drawing region L is the same, as shown in Table 4.

TABLE 4

| | First | Second | Third | Fourth |
|---|---|---|---|---|
| | exposure | exposure | exposure | exposure |
| Exposed light | 1.0 μJ/cm² | 1.0 μJ/cm² | 1.0 μJ/cm² | 1.0 μJ/cm² |
| amount of the | | | | |
| photograph | | | | |
| region P | | | | |
| Dot count of | 15% | 15% | 15% | 15% |
| the character/ | | | | |
| line drawing | | | | |
| Exposed light | 1.20 μJ/cm² | 1.30 μJ/cm² | 1.35 μJ/cm² | 1.40 μJ/cm² |
| amount of the | | | | |
| character/ | | | | |
| line drawing | | | | |
| region L | | | | |

Under the conditions shown in Table 4, the quality of the character/line drawing region L and the photograph region P of the print sample S shown in FIG. 6 was evaluated. With regard to the exposure energy of each color, the exposed light amount gets greater as the order of the transfer becomes later as shown in Table 4, and thereby it is possible to reduce ribs in the character/line drawing region L.

In example 5, the print sample S was prepared as shown in FIG. 6 and the exposed light amount was greater as the order of the transfer was later for the image information in which the dot count of each color of the character/line drawing region L was smaller as the order of the transfer was late, as shown in Table 5.

TABLE 5

| | First | Second | Third | Fourth |
|---|---|---|---|---|
| | exposure | exposure | exposure | exposure |
| Exposed light | 1.0 μJ/cm² | 1.0 μJ/cm² | 1.0 μJ/cm² | 1.0 μJ/cm² |
| amount of the | | | | |
| photograph | | | | |
| region P | | | | |
| Dot count of | 15% | 12% | 10% | 7% |
| the character/ | | | | |
| line drawing | | | | |
| Exposed light | 1.20 μJ/cm² | 1.33 μJ/cm² | 1.40 μJ/cm² | 1.47 μJ/cm² |
| amount of the | | | | |
| character/ | | | | |
| line drawing | | | | |
| region L | | | | |

Under the conditions shown in Table 5, the quality of the character/line drawing region L and the photograph region P of the print sample S shown in FIG. 6 was evaluated. With regard to the exposure energy of each color, the exposed light amount gets greater as the order of the transfer becomes later as shown in Table 5, and thereby it is possible to reduce ribs in the character/line drawing region L.

In addition, since a line is easily broken off when the dot count of the character/line drawing region L is small, it is preferable to increase the exposed light amount. Since the dot count is small later in the order of the transfer in the example 5, the increasing ratio of the exposed light amount is greater than in the example 4. In other words, as shown in Table 5, it is possible to reduce ribs by increasing the amount of change of the exposed light amount as the dot count gets smaller.

In example 6, the print sample S was prepared as shown in FIG. 6 and the exposed light amount was greater as the order of the transfer was later for the image information in which the dot count of each color of the character/line drawing region L was greater as the order of the transfer was late, as shown in Table 6.

TABLE 6

| | First | Second | Third | Fourth |
|---|---|---|---|---|
| | exposure | exposure | exposure | exposure |
| Exposed light | 1.0 μJ/cm² | 1.0 μJ/cm² | 1.0 μJ/cm² | 1.0 μJ/cm² |
| amount of the | | | | |
| photograph | | | | |
| region P | | | | |
| Dot count of | 15% | 18% | 21% | 24% |
| the character/ | | | | |
| line drawing | | | | |
| Exposed light | 1.20 μJ/cm² | 1.27 μJ/cm² | 1.30 μJ/cm² | 1.33 μJ/cm² |
| amount of the | | | | |
| character/ | | | | |
| line drawing | | | | |
| region L | | | | |

Under the conditions shown in Table 6, the quality of the character/line drawing region L and the photograph region P of the print sample S shown in FIG. 6 was evaluated. With regard to the exposure energy of each color, the exposed light amount gets greater as the order of the transfer becomes later as shown in Table 6, and thereby it is possible to reduce ribs in the character/line drawing region L.

Furthermore, since the dot count is larger later in the order of the transfer contrary to the example 5 in the example 6, the increasing ratio of the exposed light amount is smaller than in the example 5. In other words, as shown in Table 6, it is possible to reduce ribs by decreasing the amount of change of the exposed light amount as the dot count gets greater.

In example 7, the print sample S is prepared as shown in FIG. 6, and as shown in Table 7, the exposed light amount of each color of the character/line drawing region L is fixed to the exposed light amount of the first exposure unit and the exposed light amount of the second exposure unit is changed, in comparison to the exposed light amount of each color of the photograph region P. In case of the example 7, the second exposed light amount is greater than the first exposed light amount, and the third and fourth exposed light amounts are also greater than the first exposed light amount.

TABLE 7

| | First | Second | Third | Fourth |
|---|---|---|---|---|
| | exposure | exposure | exposure | exposure |
| Photograph region P | 1.0 μJ/cm² | 1.0 μJ/cm² | 1.0 μJ/cm² | 1.0 μJ/cm² |
| Character/line | 1.0 μJ/cm² | 1.2 μJ/cm² | 1.2 μJ/cm² | 1.2 μJ/cm² |
| drawing region L | | | | |

Under the conditions shown in Table 7, the quality of the character/line drawing region L and the photograph region P of the print sample S shown in FIG. 6 was evaluated. It was possible to suppress ribs in a character and to obtain sufficient grayscale expression even in a photograph. Particularly, in a pattern in which the liquid developer is superimposed as a color character, it is possible to reduce the occurrence of ribs by raising the exposure energy later in the order.

In example 8, the print sample S is prepared as shown in FIG. 6, and as shown in Table 8, the exposed light amount of each color of the character/line drawing region L is fixed to the exposed light amount of the second exposure unit and the exposed light amount of the first exposure unit is changed, in comparison to the exposed light amount of each color of the photograph region P. In case of the example 8, the first exposed light amount is smaller than the second exposed light amount, and the third and fourth exposed light amounts are also greater than the second exposed light amount.

TABLE 8

| | First | Second | Third | Fourth |
|---|---|---|---|---|
| | exposure | exposure | exposure | exposure |
| Photograph region P | 1.0 μJ/cm² | 1.0 μJ/cm² | 1.0 μJ/cm² | 1.0 μJ/cm² |
| Character/line | 0.9 μJ/cm² | 1.0 μJ/cm² | 1.1 μJ/cm² | 1.2 μJ/cm² |
| drawing region L | | | | |

Under the conditions shown in Table 8, the quality of the character/line drawing region L and the photograph region P of the print sample S shown in FIG. 6 was evaluated. It was possible to suppress ribs in a character and to obtain sufficient grayscale expression even in a photograph. Particularly, in a pattern in which the liquid developer is superimposed as a color character, it is possible to reduce the occurrence of ribs by raising the exposure energy later in the order.

The image forming apparatus according to the present embodiment is provided with the first photoreceptor 10Y where the first latent image is formed, the first charging unit 11Y that charges the first photoreceptor 10Y, the first exposure unit 12Y that exposes the first photoreceptor 10Y charged by the first charging unit 11Y to light to form the first latent image, the first developing unit 30Y that develops the first latent image formed in the first photoreceptor 10Y with the first liquid developer, the second photoreceptor 10M where a second latent image is formed, the second charging unit 11M that charges the second photoreceptor 10M, the second exposure unit 12M that exposes the second photoreceptor 10M charged by the second charging unit 11M to light to form the second latent image, a second developing unit 30M that develops the second latent image formed in the second photoreceptor 10M with the second liquid developer, the transfer member 40 where a developed image of the first photoreceptor 10Y is transferred and then a developed image of the second photoreceptor 10M is transferred, the color conversion unit 112 where image data including image information is input, and the light amount controlling unit 122 that adjusts the exposed light amount of the first exposure unit 12Y or the exposed light amount of the second exposure unit 12M according to the image information of the image data input to the color conversion unit 112.

Furthermore, the light amount controlling unit 122 controls the exposed light amount of the first exposure unit 12Y or the exposed light amount of the second exposure unit 12M to make the exposed light amount of the second exposure unit 12M greater than the exposed light amount of the first exposure unit 12Y.

Furthermore, the image forming apparatus according to the present embodiment is provided with the first photoreceptor 10Y where the first latent image is formed, the first charging unit 11Y that charges the first photoreceptor 10Y, the first exposure unit 12Y that exposes the first photoreceptor 10Y charged by the first charging unit 11Y to light to form the first latent image, the first developing unit 30Y that develops the first latent image formed in the first photoreceptor 10Y with the first liquid developer, the second photoreceptor 10M where a second latent image is formed, the second charging unit 11M that charges the second photoreceptor 10M, the second exposure unit 12M that exposes the second photoreceptor 10M charged by the second charging unit 11M to light to form the second latent image, a second developing unit 30M that develops the second latent image formed in the second photoreceptor 10M with the second liquid developer, the transfer member 40 where a developed image of the first photoreceptor 10Y is transferred and then a developed image of the second photoreceptor 10M is transferred, the color conversion unit 112 where image data including image information is input, and the light amount controlling unit 122 that adjusts the exposed light amount of the first exposure unit 12Y or an exposed light amount of the second exposure unit 12M according to the image information of the image data input to the color conversion unit 112.

Furthermore, the light amount controlling unit 122 performs control to make the exposed light amount of the second exposure unit 12M greater than the exposed light amount of the first exposure unit 12Y.

Furthermore, the light amount controlling unit 122 makes a difference between the exposed light amount of the first exposure unit 12Y and the exposed light amount of the second exposure unit 12M controlled when the image information is the first image information different from a difference between the exposed light amount of the first exposure unit 12Y and the exposed light amount of the second exposure unit 12M controlled when the image information is the second image information which is different from the first image information.

Furthermore, the light amount controlling unit 122 controls the exposed light amount of the first exposure unit 12Y or the exposed light amount of the second exposure unit 12M so as to have the first exposed light amount when the number of printed dots in a predetermined region of the image data is the first number of printed dots, and controls the exposed light amount of the first exposure unit 12Y or the exposed light amount of the second exposure unit 12M so as to have a second exposed light amount, which is greater than the first exposed light amount, when the number of printed dots in the predetermined region of the image data is the second number of printed dots, which is smaller than the first number of printed dots.

Moreover, the image forming method of the present embodiment includes inputting image data including image information, adjusting the exposed light amount of the first exposure unit 12Y and the exposed light amount of the second exposure unit 12M based on the image information of the image data, developing a latent image formed by exposing the first photoreceptor 10Y to light in the adjusted exposed light amount of the first exposure unit 12Y with the first liquid developer, transferring the developed image to the transfer member, developing a latent image formed by exposing a second photoreceptor 10M to light in the adjusted exposed light amount of the second exposure unit 12M with the second liquid developer, and transferring the developed image to the transfer member 40.

According to the image forming apparatus and the image forming method of the present embodiment, it is possible to reduce ribs in an image by adjusting the exposed light amount of the first exposure unit 12Y and/or the second exposure unit 12M based on the image information.

Furthermore, it is possible to easily control the exposed light amounts with a simple configuration of the image processing unit 111 and the light amount controlling unit 122.

Furthermore, it is possible to reduce ribs in an image by increasing the exposed light amount in the exposure units 12 later in the order of the transfer in which the ribs easily occur by the transfer.

Furthermore, in the present embodiment, it is possible to assume that, when the first exposure unit is the exposure unit 12Y, the second exposure unit may be the exposure units 12M, 12C, and 12K, when the first exposure unit is the exposure unit 12M, the second exposure unit may be the exposure units 12C, and 12K, and when the first exposure unit is the exposure unit 12C, the second exposure unit may be the exposure unit 12K.

The entire disclosure of Japanese Patent Application Nos: 2009-48765, filed Mar. 3, 2009 and 2009-246426, filed Oct. 27, 2009 are expressly incorporated by reference herein.

What is claimed is:

1. An image forming apparatus comprising:
a first latent image carrier that a first latent image is formed;
a first charging unit that charges the first latent image carrier;
a first exposure unit that exposes the first latent image carrier charged by the first charging unit to light to form the first latent image;
a first developing unit that develops the first latent image formed in the first latent image carrier with a first liquid developer;
a second latent image carrier that a second latent image is formed;
a second charging unit that charges the second latent image carrier;
a second exposure unit that exposes the second latent image carrier charged by the second charging unit to light to form the second latent image;
a second developing unit that develops the second latent image formed in the second latent image carrier with a second liquid developer;
a transfer member that a developed image of the first latent image carrier is transferred and then a developed image of the second latent image carrier is transferred;
an input unit that image data including image information is input; and
a light amount controlling unit that adjusts an exposed light amount of the first exposure unit or an exposed light amount of the second exposure unit according to the image information of the image data input to the input unit.

2. The image forming apparatus according to claim 1, wherein the light amount controlling unit controls the exposed light amount of the first exposure unit or the exposed light amount of the second exposure unit to make the exposed light amount of the second exposure unit greater than the exposed light amount of the first exposure unit.

3. An image forming apparatus comprising:
a first latent image carrier that a first latent image is formed;
a first charging unit that charges the first latent image carrier;
a first exposure unit that exposes the first latent image carrier charged by the first charging unit to light to form the first latent image;
a first developing unit that develops the first latent image formed in the first latent image carrier with a first liquid developer;
a second latent image carrier that a second latent image is formed;
a second charging unit that charges the second latent image carrier;
a second exposure unit that exposes the second latent image carrier charged by the second charging unit to light to form the second latent image;
a second developing unit that develops the second latent image formed in the second latent image carrier with a second liquid developer;
a transfer member that a developed image of the first latent image carrier is transferred and then a developed image of the second latent image carrier is transferred;
an input unit that image data including image information is input; and
a light amount controlling unit that adjusts an exposed light amount of the first exposure unit and an exposed light amount of the second exposure unit according to the image information of the image data input to the input unit.

4. The image forming apparatus according to claim 3, wherein the light amount controlling unit performs control to make the exposed light amount of the second exposure unit greater than the exposed light amount of the first exposure unit.

5. The image forming apparatus according to claim 3, wherein the light amount controlling unit makes a difference between the exposed light amount of the first exposure unit and the exposed light amount of the second exposure unit controlled when the image information is first image information different from a difference between the exposed light amount of the first exposure unit and the exposed light amount of the second exposure unit controlled when the image information is second image information that is different from the first image information.

6. The image forming apparatus according to claim 3, wherein the light amount controlling unit controls the exposed light amount of the first exposure unit or the exposed light amount of the second exposure unit so as to have a first exposed light amount when the number of printed dots in a predetermined region of the image data is a first number of printed dots, and controls the exposed light amount of the first exposure unit or the exposed light amount of the second exposure unit so as to have a second exposed light amount, that is greater than the first exposed light amount, when the number of printed dots in the predetermined region of the image data is a second number of printed dots, that is smaller than the first number of printed dots.

7. An image forming method comprising:
inputting image data including image information;
adjusting an exposed light amount of a first exposure unit and an exposed light amount of a second exposure unit based on the image information of the image data;
developing a latent image formed by exposing a first latent image carrier to light in the adjusted exposed light amount of the first exposure unit with a first liquid developer;
transferring the developed image to a transfer member;
developing a latent image formed by exposing a second latent image carrier to light in the adjusted exposed light amount of the second exposure unit with a second liquid developer; and
transferring the developed image to the transfer member.
